(19) United States
(12) Patent Application Publication
(10) Pub. No.: US 2007/0018550 A1
(43) Pub. Date: Jan. 25, 2007

(54) Reflector lamp

(75) Inventor: Markus Kolodziejczyk, Berlin (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: Patent-Treuhand-Gesellschaft fur elektrische Gluhlampen mbH, Munchen (DE)

(21) Appl. No.: 11/485,230

(22) Filed: Jul. 12, 2006

(30) Foreign Application Priority Data
Jul. 19, 2005 (DE) 20 2005 011 364.6

(51) Int. Cl. H01K 1/26; H01K 1/30; H01J 61/40; H01J 5/16

(52) U.S. Cl. 313/113

(57) ABSTRACT

A reflector lamp is disclosed that has an integral lamp, in particular a high pressure discharge lamp, that is surrounded at least partially by a reflector, the reflector being connected to a base via a reflector neck and having a light exit opening. According to the invention, the light exit opening of the reflector is covered at least partially indirectly or directly by a cover disk arrangement that has an optical spectral filter that absorbs or reflects undesired optical spectra.

### TECHNICAL FIELD

The invention relates to a reflector lamp in accordance with the preamble of patent claim 1.

### BACKGROUND ART

In principle, the inventive reflector lamp can be used as light source in a multiplicity of different optical applications. The main field of application of the reflector lamp may well, however, lie in medical technology and projection technology, for example in endoscopes or projectors.

Such reflector lamps are, for example, described under the product name “XBO®R” in the Internet domain www.osram.de. These conventional reflector lamps essentially consist of an XBO® high pressure discharge lamp that is used as an integral lamp in a reflector made from pressed glass and is partially surrounded by the reflector. In addition to the visible part of the optical spectrum, such high pressure discharge lamps also emit undesired UV and IR radiation that interfere, in particular for optical applications in which only visible light is used, for example in endoscopy technology or projection technology, since optical components of the application equipment can be overheated owing to the IR radiation components, or else they can experience premature ageing because of the UV radiation. Moreover, it is disadvantageous that in the event of bursting of the lamp vessel such reflector lamps that have a lamp vessel with a high internal pressure (approximately 5 to 15 bar) put persons and equipment at risk from fragments and particles that emerge.

In order to reduce the IR radiation components, it is known from the general prior art to provide the reflectors of such reflector lamps with cold light reflection that transmits a portion of the IR radiation emitted by the high pressure discharge lamp such that these undesired optical spectra do not reach the optical components of the appliance. It is also known to construct the discharge vessel of such high pressure discharge lamps from doped silica glass in order to absorb the UV radiation components in the short wave UV region (UVC region) from approximately 250 to 100 nm and therebelow. However, it has emerged that the IR and UV radiation components emitted by the reflector lamp continue to be too high, particularly for high quality optical applications, and so it is necessary to reduce the UV/IR radiation further by installing additional optical filter disks in the appliance in order to supply optical components, for example light guides or optical integrators, lying downstream thereof only with the desired optical spectra in the visible wavelength region. These solutions certainly enable efficient coupling out of the IR radiation spectrum and filtering out of the UV component, but they are complicated and cost intensive because of the filter disks additionally required in the appliance.

### DISCLOSURE OF THE INVENTION

It is an object of the invention to provide a reflector lamp in which, by contrast with conventional solutions, the undesired IR and UV spectra can be coupled out and/or filtered out in conjunction with a minimal technical outlay on apparatus.

This object is achieved by means of a reflector lamp having an integral lamp, in particular a high-pressure discharge lamp, that is surrounded at least partially by a reflector, the reflector being connected via a reflector neck to a base and having a light exit opening, wherein the light exit opening of the reflector is covered at least partially indirectly or directly by a cover disk arrangement that has an optical spectral filter that absorbs or reflects undesired optical spectra.

The inventive reflector lamp has an integral lamp, in particular a high-pressure discharge lamp, that is surrounded at least partially by a reflector, the reflector being connected via a reflector neck to a base and having a light exit opening. According to the invention, the light exit opening of the reflector is covered at least partially indirectly or directly by a cover disk arrangement integrated in the reflector lamp that has an optical spectral filter that absorbs or reflects undesired optical spectra. On the basis of the cover disk arrangement with an optical spectral filter, this solution enables the undesired optical spectra to be coupled out in conjunction with a high transmittance for light in the visible wavelength region. By suitable selection of the cover disk arrangement, it is possible for the. IR radiation component and/or the UV component to be coupled out or filtered out. Consequently, by contrast to the general prior art it is possible to dispense with additional filter disks in the beam path of the appliance. Furthermore, the cover disk arrangement protects people and apparatus against fragments and particles in the event of bursting of the lamp vessel.

In accordance with a particularly preferred exemplary embodiment of the invention, the cover disk arrangement has a low transmission for light in the ultraviolet wavelength region and/or in the infrared wavelength region. Consequently, the UV and/or IR radiation components undesired for optical applications in the case where visible light is used are substantially filtered out by the cover disk arrangement, and overheating of the optical components of the appliance by IR radiation components, and premature ageing owing to UV radiation, are prevented.

The cover disk arrangement preferably consists of at least one filter disk made from coated or doped glass. A high transmission in the visible wavelength region in conjunction with good heat/light separation and UV filtering can be achieved by the use of a filter disk made from coated or doped glass. Filter disks made from doped glass are distinguished by a selective absorption in a defined optical wavelength, for example in the IR region (heat-absorbing glasses).

The cover disk arrangement preferably has a substantially circular cross section.

In the case of one inventive exemplary embodiment, the cover disk arrangement has at least one glass disk without a filter effect. Owing to the additional glass disk, it is possible for the effect of the cover disk arrangement in protecting against fragments to be further improved, and for the filter disk to be protected against damage from outside.

It has proved to be particularly advantageous when the cover disk arrangement has an interference filter coating with a number of optically low index layers and optically high index layers. Because of the layer design of the interference filter coating, interference effects result in a high transmission in the visible optical region in conjunction with reflection of undesired optical spectra.

The cover disk arrangement is preferably optimized in such a way that one filter edge lies in the ultraviolet spectral region, in particular in a wavelength region from 360 to 400 nm, and/or one filter edge lies in the transition region from the visible spectral region to the infrared spectral region, in particular in a wavelength region from 700 to 800 nm. Because of the steep filter edges, the undesired UV/IR optical spectra are extinguished in conjunction with improved transmission of light in the visible wavelength region.

In the case of one embodiment of the invention, the cover disk arrangement is inserted at least partially into a holder of the reflector. This permits a compact design of the reflector lamp.

In accordance with a particularly preferred exemplary embodiment, the cover disk arrangement is connected to the reflector via a filter holder.

The filter holder is preferably a front cap that is substantially adapted to the contour of the reflector at the periphery.

In the case of one inventive exemplary embodiment, the cover disk arrangement is arranged on an end face of the filter holder, or is inserted at least partially into a fastening section of the front cap.

It has proved to be particularly advantageous when a fastening section, in the shape of a lateral cylinder surface, of the filter holder is reduced on the light exit side to a holding section for the cover disk arrangement. The cover disk arrangement can be reduced in conjunction with the compact design of the reflector lamp on the basis of the reduced end face of the holder section, and the protective effect against fragments can thereby be further improved.

The filter holder can preferably be brought to bear at its end face against the reflector via a substantially annular flange. In order to position and center the filter holder on the reflector, the filter holder preferably has an annular centering projection that engages in the light exit opening of the reflector.

In the case of one preferred embodiment of the invention, the cover disk arrangement is connected to the filter holder or to the reflector, and/or the filter holder is connected to the reflector via holding elements, in particular holding lugs.

In accordance with a further design variant, the cover disk arrangement is connected to the filter holder or the reflector, and/or the filter holder is connected to the reflector via a connecting compound, in particular an adhesive.

It has proved to be advantageous to construct the filter holder from a high temperature resistant material, preferably a plastic.

The integral lamp is preferably a xenon high pressure discharge lamp. Such a short-arc discharge lamp enables a high luminance and a continuous spectrum in the visible region in conjunction with a high color rendition index (Ra>95).

The reflector lamp according to the invention is preferably used in scientific apparatuses, in particular endoscopes.

### BRIEF DESCRIPTION OF THE DRAWINGS

The invention is explained in more detail below with the aid of a preferred exemplary embodiment. In the drawing:

FIG. 1 shows a schematic of a reflector lamp according to the invention with a cover disk arrangement, and

FIG. 2 shows a transmission curve of the reflector lamp according to the invention from FIG. 1, and a transmission curve of a conventional reflector lamp.

### BEST MODE FOR CARRYING OUT THE INVENTION

The invention is explained below with the aid of a reflector lamp having as integral lamp an XBO® high pressure discharge lamp that is used, for example, in medical technology as light source of endoscopy apparatuses. As already mentioned at the beginning, the reflector lamp according to the invention is, however, not in any way restricted to such types of lamp and applications.

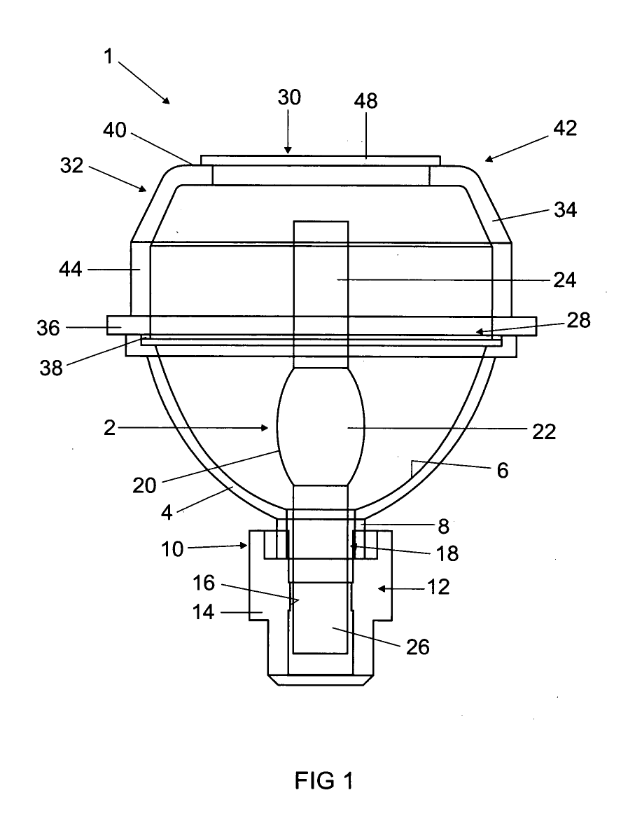

FIG. 1 shows a schematic of a reflector lamp 1 according to the invention, having an integral lamp 2 that is partially surrounded by a substantially ellipsoidal reflector 4 made from pressed glass. The reflector 4 is provided on an inner surface 6 with a reflective coating, and is inserted into a holding section 10 of a base 12 via a cylindrical reflector neck 8. The base 12 has a substantially cylindrical basic body 14 that is provided on the lamp side with two diametrically arranged, approximately U-shaped cutouts 16. The integral lamp 2 is fastened in the base 12 in a fashion axially offset from the installed position of the reflector 4 so as to produce a ventilation opening 18 between the integral lamp 2 and base 12 or base 12 and reflector neck 8, through which a cooling air current is guided into the base region of the reflector lamp 1 by means of a fan (not illustrated).

Use is made as integral lamp 2 in the case of the exemplary embodiment shown of an XBO® high pressure discharge lamp of short-arc design. Said lamp has a discharge vessel 20 made from silica glass and having an interior 22 and two diametrically arranged, sealed bulb shafts 24, 26 that respectively have a current feedthrough (not illustrated). Protruding into the interior 22 are two diametrically arranged electrodes (not illustrated) that are respectively connected to one of the current feedthroughs via a molybdenum foil seal, and between which a gas discharge forms during the operation of the lamp. Enclosed in the interior 22 of the discharge vessel 20 is an ionizable filling that consists essentially of high purity xenon gas. Such an XBO® high pressure discharge lamp 2 enables a high luminance of the reflector lamp 1 and a continuous spectrum in the visible spectral region in conjunction with a high color rendition index (Ra>95). The electric connection of the XBO® high pressure discharge lamp 2 to the supply voltage is performed at the current feedthrough remote from the base via a high voltage cable (not illustrated) led through a cable feedthrough in the reflector 4. Contact is made with the current feedthrough of the bulb shaft 26, near the base, of the discharge vessel 20 via a high voltage cable (not illustrated), and the feedthrough is led to the outside at the base 12. The two high voltage cables are combined outside the reflector lamp 1 in a contact plug, and can be connected via the latter to an electronic starting and operating system (not illustrated).

According to the invention, a light exit opening 28 of the reflector 4 is covered by a cover disk arrangement 30 that has an optical spectral filter that absorbs or reflects undesired optical spectra. Because of the cover disk arrangement 30 with an optical spectral filter, this solution enables a virtually complete reflection or absorption of the undesired optical spectra, the visible light component experiencing essentially no attenuation by the cover disk arrangement 30. Depending on the field of application desired for the reflector lamp 1, it is possible by suitable selection of the cover disk arrangement 30 to filter out the IR radiation component and/or the UV radiation component of the emitted optical spectrum of the high pressure discharge lamp 2. By contrast with the general prior art, therefore, it is possible to dispense with additional filter disks in the optical appliance (not illustrated), for example an endoscope. In accordance with FIG. 1, the cover disk arrangement 30 is connected to the reflector 4 via a filter holder 32 that is essentially in the shape of a lateral cylinder surface and is made from a high temperature resistant plastic, the filter holder 32 being designed as a front cap 34 adapted at the periphery to the contour of the reflector 4. The front cap 34 is brought to bear against the reflector 4 via an annular flange 36, and is positioned with reference to the light exit opening 28 via an annular centering projection 38. The reflector lamp 1 can be brought to bear against an optical appliance (not illustrated) via the flange 36. In the case of the reflector lamp 1 shown, the front cap 34 is connected to the reflector 4 via holding elements, for example holding lugs (not illustrated). In order to hold the cover disk arrangement 30, an end face 40 of the front cap 34 is reduced on the light exit side to a holding section 42 that is in the shape of a lateral conical surface and merges on the base side into a fastening section 44 in the shape of a lateral cylinder surface. Because of the reduced end face 40 of the holding section 42, the cover disk arrangement 30 can be reduced in conjunction with a compact design of the reflector lamp 1, and the protection against fragments can thereby be improved.

The cover disk arrangement 30 is arranged on the end face 40 of the front cap 34 and is fastened to the front cap via holding elements, for example holding lugs (not illustrated).

In an embodiment of the reflector lamp 1 that is not illustrated, the cover disk arrangement 30 is inserted at least partially into a holder of the front cap. In a further variant of the reflector lamp 1, the cover disk arrangement 30 is connected to the front cap 34, and/or the front cap 34 is connected to the reflector 4 via an adhesive.

In the case of the exemplary embodiment that is shown for the reflector lamp 1, the cover disk arrangement 30 comprises a single circular filter disk 48 made from glass that is provided with an interference filter coating (not illustrated). The layer structure of the interference filter comprises a number of optically low index and optically high index layers that are applied, for example, in an alternating fashion to the filter disk 48 using sputtering technology. A high transmittance for light in the visible wavelength region in conjunction with good IR and UV filtering is achieved on the basis of the layer design of the interference filter coating.

In the case of an alternative design, the filter disk 48 is additionally covered on the light exit side by a glass disk without a filter effect. The effects of the filter disk 48 in protecting against fragments can thereby be further improved, and said disk can be protected against damage from outside.

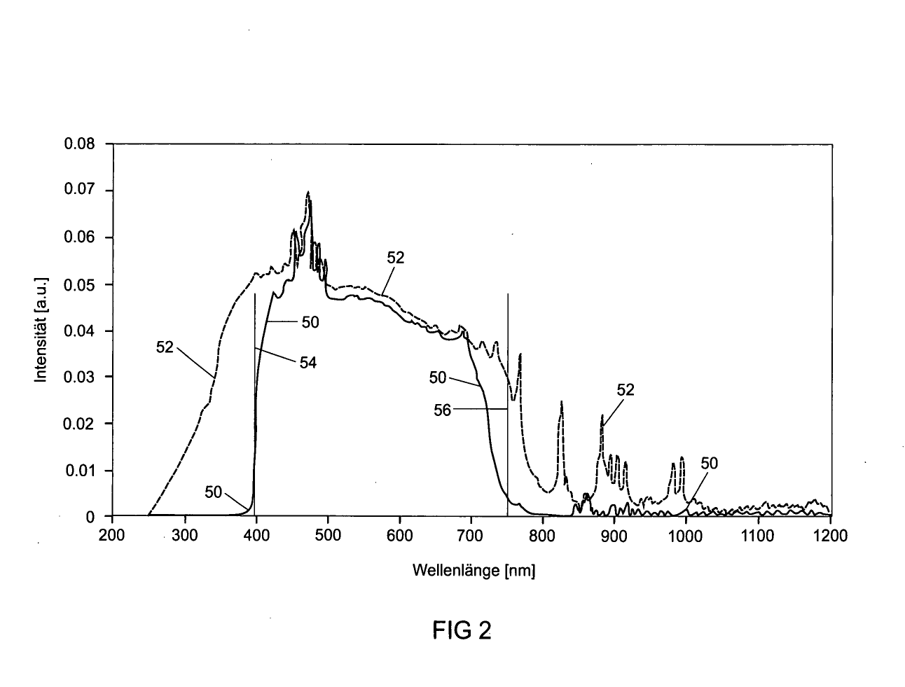

The transmission behavior of the reflector lamp 1 according to the invention and having a cover disk arrangement 30 (see FIG. 1) is illustrated in FIG. 2 by a curve 52, and the transmission behavior of a conventional reflector lamp of type “XBO®-R 300W/60 C OFR” is illustrated by a curve 52 indicated by dots and dashes. In accordance with the curve 52, the cover disk arrangement 30 of the reflector lamp 1 according to the invention is designed in such a way that undesired ultraviolet and infrared wavelength regions as compared with the curve 52 of the conventional reflector lamp are for the most part filtered out in a wavelength region below 380 nm and above 780 nm, and a higher transmittance is achieved for light in the visible wavelength region from 380 to 780 nm. Consequently, the UV and IR radiation components that are undesired for optical applications in which visible light is used are substantially filtered out, and overheating of the optical components in the beam path by IR radiation components, and premature ageing thereof owing to UV radiation are prevented. In accordance with FIG. 2, the cover disk arrangement 30 is optimized in such a way that a filter edge 54 lies at a wavelength of approximately 390 nm in the ultraviolet spectral region, and a filter edge 56 lies at a wavelength of approximately 750 nm in the transition region from the visible into the infrared spectral region. Because of the steep profile of the curve 52 in the region of the filter edges 54, 56, the undesired UV/IR optical spectra are filtered out or coupled out in conjunction with good transmission of light in the visible wavelength region.

The reflector lamp 1 according to the invention is not restricted to the described design with a filter holder 32; rather, in the case of reflector lamps 1 with integral lamps 2 inserted entirely into the reflector 4 the cover disk arrangement 30 can be inserted directly into a holder of the reflector 4. It is essential to the invention that the light exit opening 28 of the reflector 4 of the reflector lamp 1 be at least partially covered indirectly or directly by the cover disk arrangement 30, and that the latter have an optical spectral filter that absorbs or reflects undesired optical spectra.

A reflector lamp 1 is disclosed that has an integral lamp 2, in particular a high pressure discharge lamp, that is at least partially surrounded by a reflector 4, the reflector 4 being connected to a base 12 via a reflector neck 8 and having a light exit opening 28. According to the invention, the light exit opening 28 of the reflector 4 is covered at least partially indirectly or directly by a cover disk arrangement 30 that has an optical spectral filter that absorbs or reflects undesired optical spectra.

1. A reflector lamp having an integral lamp, in particular a high-pressure discharge lamp, that is surrounded at least partially by a reflector, the reflector being connected via a reflector neck to a base and having a light exit opening, wherein the light exit opening of the reflector is covered at least partially indirectly or directly by a cover disk arrangement that has an optical spectral filter that absorbs or reflects undesired optical spectra.

2. The reflector lamp as claimed in claim 1, in which the cover disk arrangement has a low transmission for light in the ultraviolet wavelength region and/or in the infrared wavelength region.

3. The reflector lamp as claimed in claim 1, in which the cover disk arrangement consists of at least one filter disk made from coated or doped glass.

4. The reflector lamp as claimed in claim 1, in which the cover disk arrangement has at least one glass disk without a filter effect.

5. The reflector lamp as claimed in claim 1, in which the cover disk arrangement has substantially a circular cross section.

6. The reflector lamp as claimed in claim 1, in which the cover disk arrangement has an interference filter coating with a number of optically low index layers and optically high index layers.

7. The reflector lamp as claimed in claim 1, in which the cover disk arrangement is optimized in such a way that one filter edge lies in the ultraviolet spectral region, in particular in a wavelength region from 360 to 400 nm, and/or one filter edge lies in the transition region from the visible to the infrared spectral region, in particular in a wavelength region from 700 to 800 nm.

8. The reflector lamp as claimed in claim 1, in which the cover disk arrangement is inserted at least partially into a holder of the reflector.

9. The reflector lamp as claimed in claim 1, in which the cover disk arrangement is connected to the reflector via a filter holder.

10. The reflector lamp as claimed in claim 9, in which the filter holder is a front cap that is substantially adapted to the contour of the reflector at the periphery.

11. The reflector lamp as claimed in claim 9, in which the cover disk arrangement is arranged on an end face of the filter holder, or is inserted at least partially into a fastening section of the filter holder.

12. The reflector lamp as claimed in claim 9, in which a fastening section, in the shape of a lateral cylinder surface, of the filter holder is reduced on the light exit side to a holding section for the cover disk arrangement.

13. The reflector lamp as claimed in claim 9, in which the filter holder can be brought to bear at its end face against the reflector via a substantially annular flange.

14. The reflector lamp as claimed in claim 9, in which the filter holder has a centering projection for centering the filter holder on the reflector.

15. The reflector lamp as claimed in claim 8, in which the cover disk arrangement is connected to the filter holder or to the reflector, and/or the filter holder is connected to the reflector via holding elements, in particular holding lugs.

16. The reflector lamp as claimed in claim 8, in which the cover disk arrangement is connected to the filter holder or the reflector, and/or the filter holder is connected to the reflector via a connecting compound, in particular an adhesive.

17. The reflector lamp as claimed in claim 9, in which the filter holder is made from a high temperature resistant material, preferably a plastic.

18. The reflector lamp as claimed in claim 1, in which the integral lamp is a xenon high pressure discharge lamp.

19. The reflector lamp as claimed in claim 15, in which the cover disk arrangement is connected to the filter holder or the reflector, and/or the filter holder is connected to the reflector via a connecting compound, in particular an adhesive.
